(19) United States
(12) Patent Application Publication
(10) Pub. No.: US 2014/0341362 A1
(43) Pub. Date: Nov. 20, 2014

(54) INTERACTIVE VOICE RESPONSE SYSTEM WITH ELECTRONIC SIGNATURE FUNCTIONALITY

(71) Applicant: INNOVATION SOFTWARE, LLC, Cedar Falls, IA (US)

(72) Inventors: Chad Benson, Cedar Falls, IA (US); Michael L. Frost, Cedar Falls, IA (US)

(21) Appl. No.: 14/449,707

(22) Filed: Aug. 1, 2014

(51) Int. Cl. H04M 3/493; H04M 3/51

(52) U.S. Cl. CPC H04M 3/493; H04M 3/5133; H04M 3/5166
USPC 379/88.02

(57) ABSTRACT

A method for receiving authorization from a consumer includes steps of connecting a phone call associated with a consumer to an interactive voice response system after the agent has conveyed the confirmation number to the consumer, receiving the confirmation number from the consumer at the interactive voice response system to provide authorization from the consumer, and storing a record of entry of the confirmation number by the consumer through the interactive voice response system in a non-transitory computer readable storage medium.

### FIELD OF THE INVENTION

The present invention relates to interactive voice response systems (IVRs). More particularly, but not exclusively, the present invention relates to methods and systems which provide electronic signatures as a part of an interactive voice response process associated with a collections system.

### BACKGROUND OF THE INVENTION

There are various instances where it may be necessary or desirable to obtain written authorizations from customers. One such example, in the U.S. relates to the legal requirement under Regulation E of the Electronic Fund Transfer Act (15 U.S.C. 1693 et seq.) that requires that any re-occurring promise of type Debit Card to have written authorization of the consumer.

Various ways of receiving this written authorization may be employed. For example, where letters or documents with associated promise to pay information are mailed to a consumer, there is inconvenience and delay. This may result in the consumer changing their mind about providing the written authorization, forgetting about it, or ignoring it. Even where a consumer promptly responds there is delay in sending the information out by mail, receiving it back from the consumer, and processing it. Therefore, problems remain.

An alternative approach to obtaining written authorization would be to send an e-mail to the consumer and within the e-mail include a link to a web site for the consumer to view an agreement. Such an approach would allow for electronic signature of the document and would eliminate some of the problems with mail. However, other problems are introduced. For example, not all consumers necessarily have easy access to the internet. In addition due to firewalls and spam filter settings and the like, such emails may never actually be delivered. Therefore, problems remain.

What are needed are methods and systems for obtaining authorization from consumers which comply with applicable laws and which eliminate the problems with alternative approaches.

### SUMMARY

Therefore, it is a primary object, feature, or advantage of the present invention to improve over the state of the art.

It is a further object, feature, or advantage of the present invention to obtain legally sufficient authorizations from consumers.

It is a still further object, feature, or advantage of the present invention to provide for obtaining written authorization while a consumer is on the phone with an agent.

It is another object, feature, or advantage of the present invention to provide for obtaining written authorization using an interactive voice response system.

Yet another object, feature, or advantage of the present invention to provide for obtaining written authorization from a consumer in a manner that is convenient for the customer.

A still further object, feature, or advantage of the present invention is to provide for obtaining written authorization from a consumer in a manner that eliminates or reduces delays in obtaining written authorization.

One or more of these and/or other objects, features, or advantages will become apparent from the specification and claims that follow. Note that no single embodiment need exhibit each and every object, feature, or advantage described herein as different embodiments may exhibit different objects, features, and advantages.

According to one aspect, a method for receiving authorization from a consumer includes steps of connecting a phone call associated with a consumer to an interactive voice response system after the agent has conveyed the confirmation number to the consumer, receiving the confirmation number from the consumer at the interactive voice response system to provide authorization from the consumer, and storing a record of entry of the confirmation number by the consumer through the interactive voice response system in a non-transitory computer readable storage medium.

According to another aspect, a method includes providing a collections relationship management system and providing an interactive voice response system. The method further includes communicating a confirmation number to an agent through the collections relationship management system, connecting a phone call associated with a consumer to the interactive voice response system after the agent has conveyed the confirmation number to the consumer, receiving the confirmation number from the consumer at the interactive voice response system to provide authorization from the consumer, and storing a record of entry of the confirmation number by the consumer through the interactive voice response system in a database stored in a non-transitory computer readable storage medium.

### BRIEF DESCRIPTION OF THE FIGURES

FIG. 1 illustrates one example of a system.

FIG. 2 illustrates a work flow according to one example.

FIG. 3 illustrates another work flow according to another example.

### DETAILED DESCRIPTION

The present invention provides for methods and systems related to an interactive voice response system (IVR) which may be used to collect electronic confirmations from individuals in manner which may be considered written authorization under the E-SIGN Act (15 U.S.C. ch. 96). Such a system may be used in various ways, including to receive written authorization from the consumer for re-occurring promises to pay using debit cards.

In operation, an agent may have a conversation with a consumer over the phone. As a part of the conversation, the consumer may be asked to electronically sign an agreement such as a form of promise arrangement such as may be used in collecting on debt incurred by the consumer. The agent will be presented with a confirmation number which the agent may communicate to the consumer and the consumer may be instructed that they will be transferred to an IVR system and asked to enter the confirmation number to indicate their authorization. Once transferred to the IVR system, the consumer will be asked to enter the confirmation number. A record of the authorization of the consumer may then be stored such as on a non-transitory computer readable storage medium.

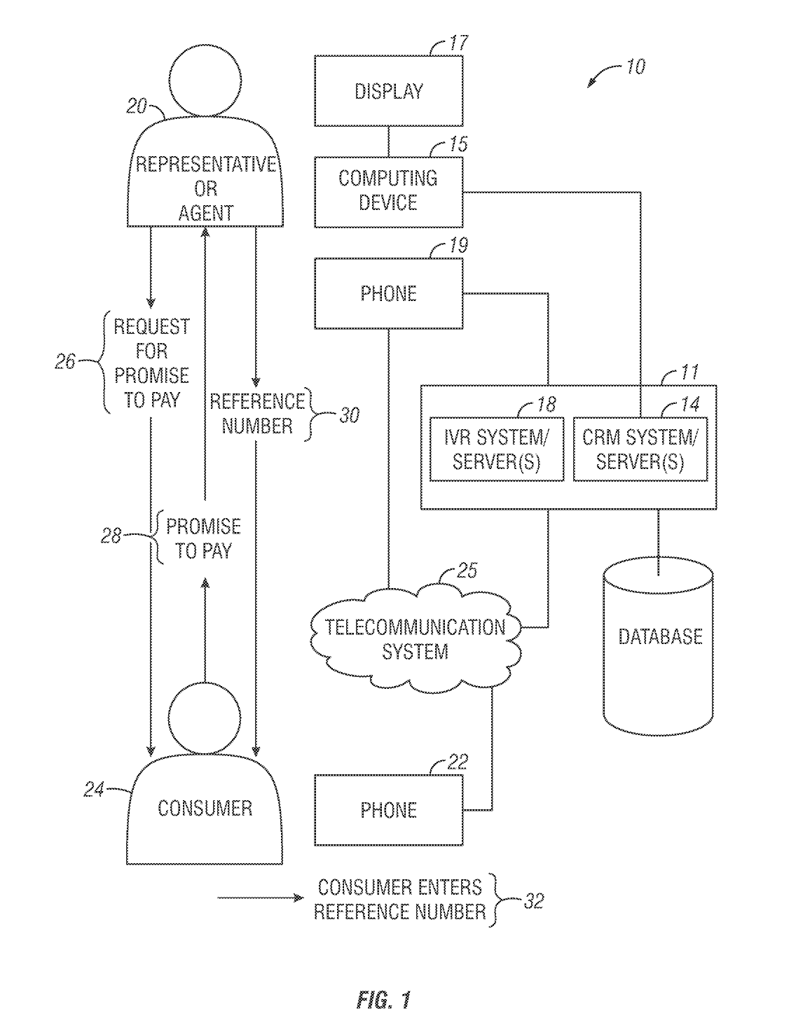

FIG. 1 illustrates a general overview of a system for debt repayment. The system 10 includes a system 11 which may include a system 14 which may include one or more servers and may be a CRM system, an IVR system 18 which may include one or more servers. The system 11 is in operative communication with a database 16 and an interactive voice response (IVR) server 18. A computing device 15 may be operatively connected to the server 14 such as through a network. A display 17 may be operatively connected to the computing device 15 for use by the representative or agent. Thus, the agent 20 may use the computing device 15 for communications with the CRM system 14 and the phone 19 for communications with the IVR server or the consumer.

A consumer 24 utilizes a phone 22 to communication with an agent or representative 20 to make a payment. The communication may occur over a telecommunication system 25. The consumer 24 and the agent 20 communicate through an IVR (interactive voice response) system 18. The IVR system 18 makes a request for promise to pay 26 to the consumer 24. If the consumer responds with a promise to pay 28, the agent 20 will generate a unique reference number 30. The consumer will enter the unique reference number 32 to e-sign for payment.

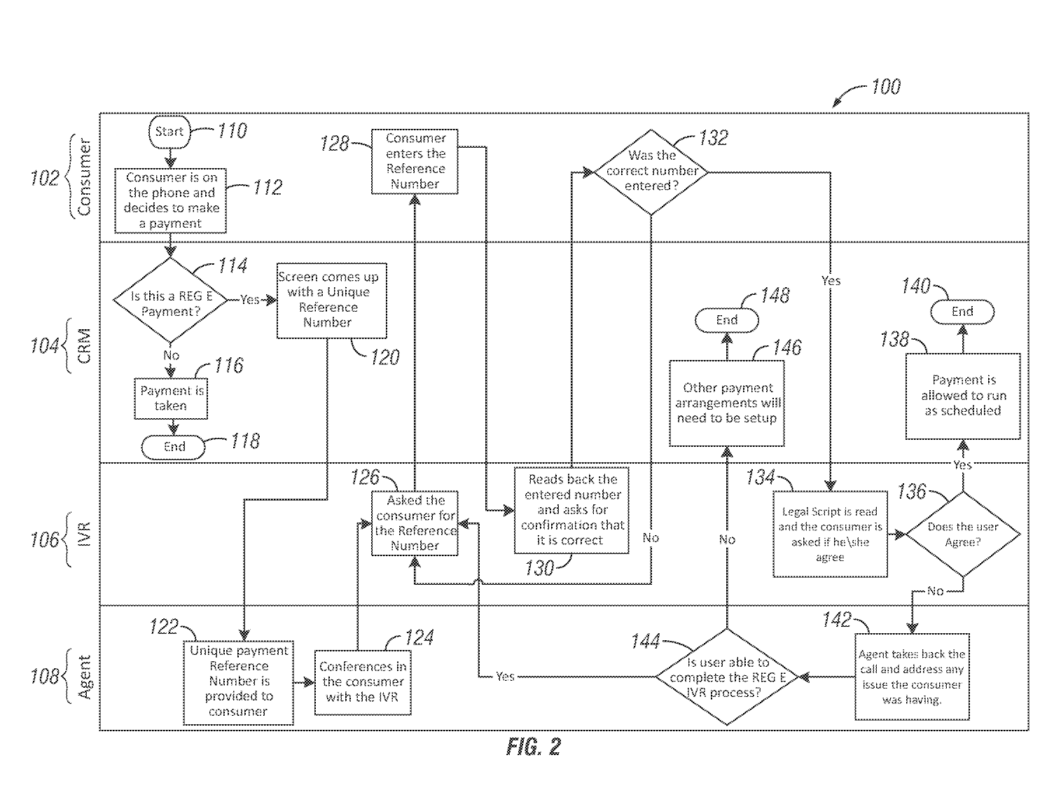

FIG. 2 illustrates a work flow of a system 100. The consumer 102, collections relationship management (CRM) 104, WR 106, and an Agent 108 are associated with the workflow of the system.

In step 110 the process starts when a consumer 102 is on the phone and decides to make a payment in step 112. In step 114 a determination is made as to whether the payment is a REG E payment or not. If it is not and written authorization is not required, then in step 116 payment may be taken and the process may then end in step 118. However, if in step 114, the payment is a payment that requires written authorization under REG E, then in step 120 a screen may be displayed to the agent through the CRM system which includes a unique reference number. Then in step 122 the agent 108 may communicate this unique payment reference number to the consumer.

Once the consumer 102 is provided the unique reference number they may then be conferenced into the IVR system 106 by the agent 108 or otherwise connected with the IVR system in step 124. Once connected with the IVR system 106, the consumer 102 is prompted for or asked for the reference number in step 126. In step 128, the consumer enters the reference number either by the phone keypad, verbally, or otherwise. The IVR system 106 reads back the entered number and then asks for confirmation that the entered number is correct in step 130. The consumer 102 may then answer yes or no in step 132. If the consumer 102 answers no, the IVR system 106 will ask for the reference number again in step 126. If the consumer 102 answers yes, a legal script is read and the consumer 102 is asked if they agree in step 134. If the consumer 102 answers no, then in step 142, the agent 108 takes the call back from the IVR system 106 and addresses any issues the consumer 102 is having. If the consumer 102 is unable to complete the REG E IVR process in step 144 the agent 108 will make other payment arrangements in step 146 and the call will end in step 148. If in step 144, the consumer 102 is able to complete the REG E IVR process the agent 108 will place the consumer 102 back into the IVR system 106 at step 126. If the consumer 102 agrees with the legal script 134 and answers yes, a payment is allowed to run as scheduled in step 138 and the process ends in step 140.

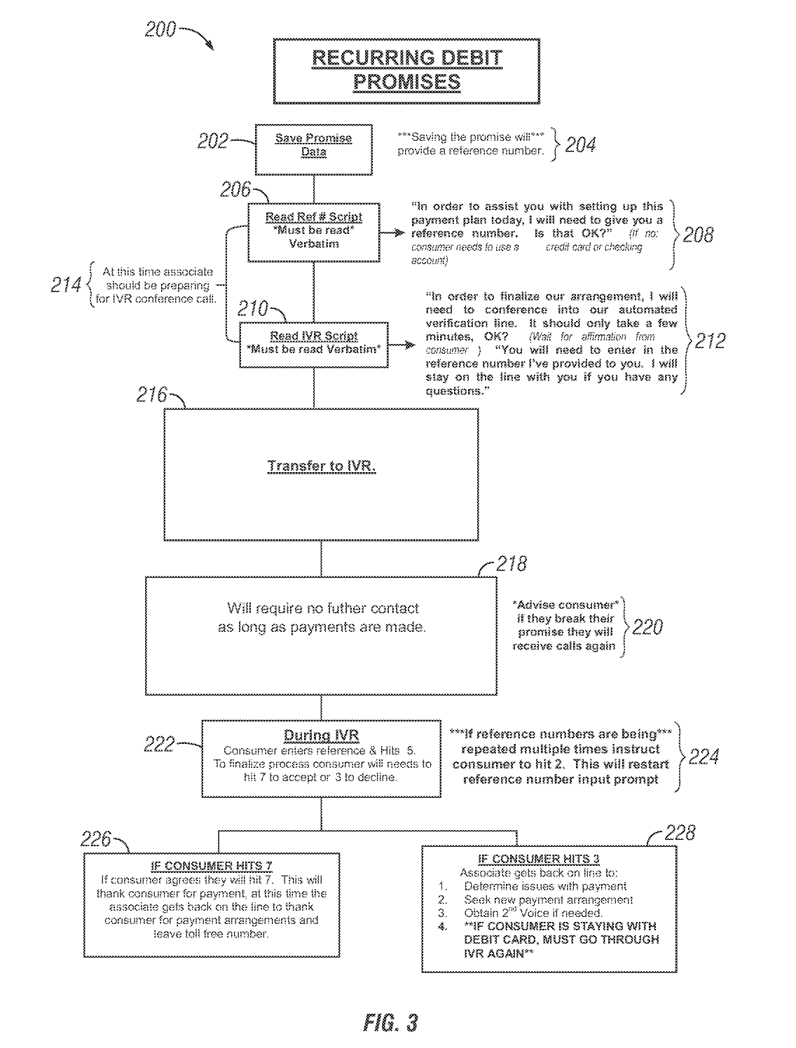

FIG. 3 illustrates a system 200 work flow regarding recurring debt promises for associate (agent) utilization when on a call with a consumer. In step 202, promise data associated with a consumer may be saved on a non-transitory computer readable storage medium associated with a system. The promise data may include information such as the amount of a recurring payment, how often the payment may re-occur, debit card information, or other relevant information. In step 206, the associate may read an appropriate script. One example of such a script 208 is shown. In step 210, the associate may read an IVR script. One example of such a script 212 is shown. While reading the scripts, in step 214, the associate may also be preparing for an IVR conference call.

In step 216, the associate may transfer the call to the IVR system. In step 218, the consumer may be advised that there will be no further contact as long as payments are made. Also in step 220 the consumer may be advised that if they break their promise they will receive calls again.

In step 222, during the IVR, the consumer may enter the reference number and hit a key to indicate that the reference number has been entered. The consumer may be asked to confirm or decline acceptance by hitting different keys. If there is confirmation of acceptance then information may be stored on a non-transitory computer readable storage medium to record the acceptance. The information stored may include the code, the time/date, and the number(s) pressed for confirmation. Such information may be stored in various forms including within an SQL database table.

In step 224, the reference number input prompt may be restarted.

In step 227, if the consumer confirms their acceptance, the IVR system may thank the consumer for their payment and the associate may also thank the consumer for making payment arrangements. In step 228, if the consumer does not confirm acceptance, the associate may get back on the link to determine if there are issues with payment, obtain new payment arrangements, obtain a second voice if needed, or to go through the IVR process again.

Thus, various embodiments have been shown and described which provide for receiving authorization for an agreement through an interactive voice response (IVR) system. Although specific embodiments are described herein, it is to be understood that the present invention contemplates numerous variations, options, and alternatives. For example, differences in the hardware systems, software systems, network topologies, and other variations are contemplated. In addition, although described in the context of debt collection management, it is contemplated that the methodology and systems shown and described may be used in other applications as well.

What is claimed is:

1. A method for receiving authorization from a consumer, the method comprising steps of:
communicating a confirmation number to an agent;
connecting a phone call associated with a consumer to an interactive voice response system after the agent has conveyed the confirmation number to the consumer;
receiving the confirmation number from the consumer at the interactive voice response system to provide authorization from the consumer;
storing a record of entry of the confirmation number by the consumer through the interactive voice response system in a non-transitory computer readable storage medium.

2. The method of claim 1 further comprising prompting the consumer through the interactive voice response system to press a number or symbol after entry of the confirmation number and if the number or symbol is not pressed, connecting the phone call associated with the consumer back to the agent.

3. The method of claim 1 wherein the step of communicating the confirmation number to the agent comprises displaying the confirmation number on a display associated with the agent.

4. The method of claim 1 wherein the step of connecting the phone call associated with the consumer to the interactive voice response system comprises conferencing the consumer, the agent, and the interactive voice response system.

5. The method of claim 1 further comprising confirming identity of the consumer through the interactive voice response system before receiving the confirmation number from the consumer.

6. A method for receiving authorization from a consumer, the method comprising steps of:
providing a collections relationship management system;
providing an interactive voice response system;
communicating a confirmation number to an agent through the collections relationship management system;
connecting a phone call associated with a consumer to the interactive voice response system after the agent has conveyed the confirmation number to the consumer;
receiving the confirmation number from the consumer at the interactive voice response system to provide authorization from the consumer;
storing a record of entry of the confirmation number by the consumer through the interactive voice response system in a database stored in a non-transitory computer readable storage medium.

7. The method of claim 6 further comprising prompting the consumer through the interactive voice response system to press a number or symbol after entry of the confirmation number and if the number or symbol is not pressed, connecting the phone call associated with the consumer back to the agent.

8. The method of claim 6 wherein the step of communicating the confirmation number to the agent comprises displaying the confirmation number on a display associated with the agent.

9. The method of claim 6 wherein the step of connecting the phone call associated with the consumer to the interactive voice response system comprises conferencing the consumer, the agent, and the interactive voice response system.

10. The method of claim 6 further comprising confirming identity of the consumer through the interactive voice response system before receiving the confirmation number from the consumer.
